(19) United States
(12) Patent Application Publication
(10) Pub. No.: US 2010/0153543 A1
(43) Pub. Date: Jun. 17, 2010

(54) Method and System for Intelligent Management of Performance Measurements In Communication Networks

(76) Inventors: Bo Lee, Alpharetta, GA (US); Spyridon Kapoulas, Atlanta, GA (US)

Correspondence Address: AT & T Legal Department - FKM, AT & T LEGAL DEPARTMENT,, ATTN: PATENT DOCKETING ROOM 2A-207, BEDMINSTER, NJ, 07921, US

(21) Appl. No.: 12/336,911

(22) Filed: Dec. 17, 2008

(51) Int. Cl. G06F 15/16

(52) U.S. Cl. 709/224

(57) ABSTRACT

A system and method operable to monitor a parameter of a node of a communications network, enable one of a plurality of performance measurements for the node based on an enable threshold of the parameter and disable the one of the performance measurements based on a disable threshold of the parameter.

### BACKGROUND

As telecommunications systems evolve and become more complex, the number and complexity of performance measurements (“PMs”) required to monitor, maintain and optimize network performance is substantially increased. The active use of a large number of PMs creates significant overhead in the management, storage and presentation of data. To reduce this overhead, only a portion of the available PMs are typically actively collecting data at any given time.

The selection of which PMs should be active at a given time is an important one. If appropriate PMs are inactive, there may be insufficient available information to resolve service problems that may occur. However, if more PMs are active than are necessary, network resources may be used inefficiently.

### SUMMARY OF THE INVENTION

A computer readable storage medium including a set of instructions executable by a processor, the set of instructions being operable to monitor a parameter of a node of a communications network, enable one of a plurality of performance measurements for the node based on an enable threshold of the parameter and disable the one of the performance measurements based on a disable threshold of the parameter.

A system having a monitoring element configured to monitor a performance of nodes of a communication network, an analysis element configured to analyze the performance and a configuration element configured to determine whether to enable a performance measurement for one of the nodes.

### BRIEF DESCRIPTION OF THE DRAWINGS

FIG. 1 shows an exemplary system for managing performance measurements according to the present invention.

FIG. 2 shows a first exemplary method for managing performance measurements according to the present invention.

FIG. 3 shows a second exemplary method for managing performance measurements according to the present invention.

### DETAILED DESCRIPTION

The exemplary embodiments of the present invention may be further understood with reference to the following description and the appended drawings, wherein like elements are referred to with the same reference numerals. The exemplary embodiments describe methods and systems for managing the operation of performance measurements (“PMs”) in communications networks intelligently and efficiently. Values measured by PMs may include packet loss, jitter, delay, access failures, mobility failures, radio resource management failures, transport network failures, abnormally terminated calls or sessions, application layer failures, etc.

As described above, the selection of PMs to activate from among those that are available is an important one, as a balance must be maintained between collecting necessary information and utilizing system resources efficiently. To achieve this result, the exemplary embodiments of the present invention adopt an intelligent management of performance measurements (“IMPM”) based on analysis of current, past and/or forecasted performance of a network. The goal of IMPM is to enable only those PMs that are required at a given time. PMs that are not required because performance goals have been met may be disabled, while PMs that are required because performance goals have not been met may be enabled. This enabling and disabling may be a manual or automatic process.

The exemplary embodiments present cost-efficient methods and systems for managing performance measurements needed for monitoring, troubleshooting and optimizing network health and quality of services offered; to analyze such details to determine if additional performance measurements should be activated or deactivated; to create a sequence of actions that specifies necessary changes in the configuration of performance measurements; and to perform these actions.

The exemplary embodiments describe three functionalities that interact with one another as will be described below. While the three functionalities are described separately, those skilled in the art will understand that these three functionalities may be reside in or be performed separate components or a single component (hardware component, software component or combination thereof). The first of the three is a monitoring function. This function determines whether and when an issue exists by using historical and current PM data, together with performance goals and other technical information. If an issue is identified (e.g., accessibility to a resource has degraded, network traffic is moving slowly, etc.), the monitoring function may send a symptom report to an analysis function for further processing. The monitoring function may include a symptoms database, which may be internal to the monitoring function or may be a separately maintained database. The symptoms database may contain issue descriptions related to PMs as well as to configuration management (“CM”) and fault management (“FM”), as well as to frequency of issue occurrences based on historical data.

The second of the three functions is an analysis function. This function determines the nature of a problem affecting the area of investigation. Once this determination has been made, the analysis function may send a modification or change request to a configuration function. The analysis function may also include a diagnosis engine that correlates PM, CM and FM data and models complex situations. The third function is a configuration function, which is responsible for enabling or disabling PMs by following various policies related to business and engineering rules (e.g., enabling new PMs may depend on the amount of resources they require as well as the severity of problems to be solved).

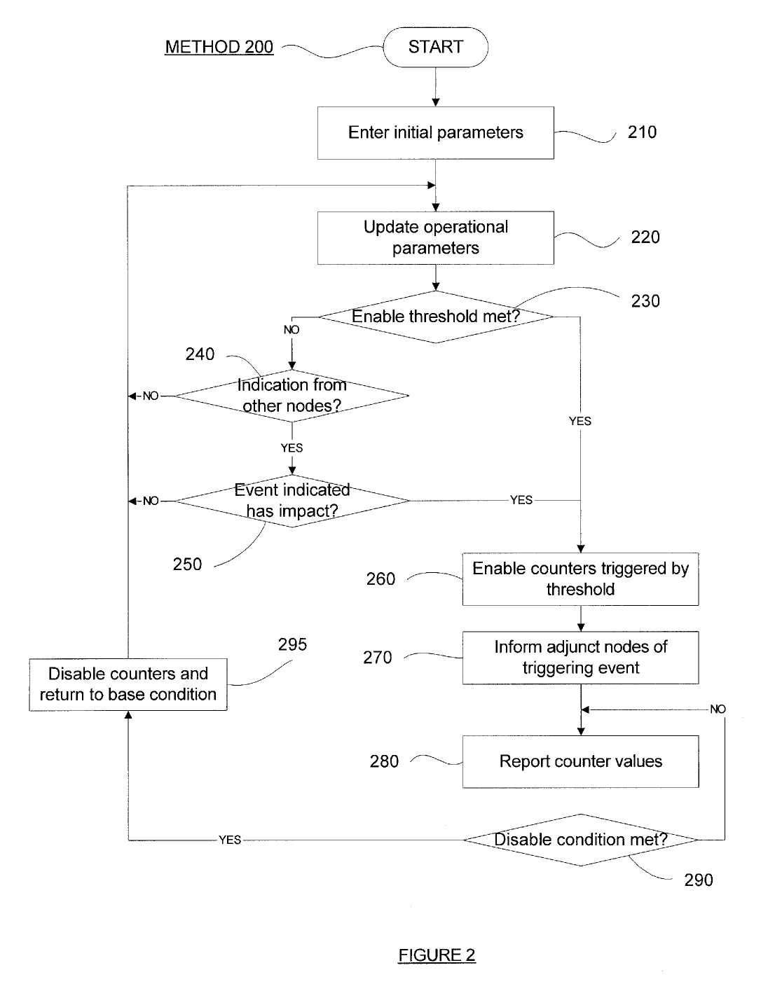

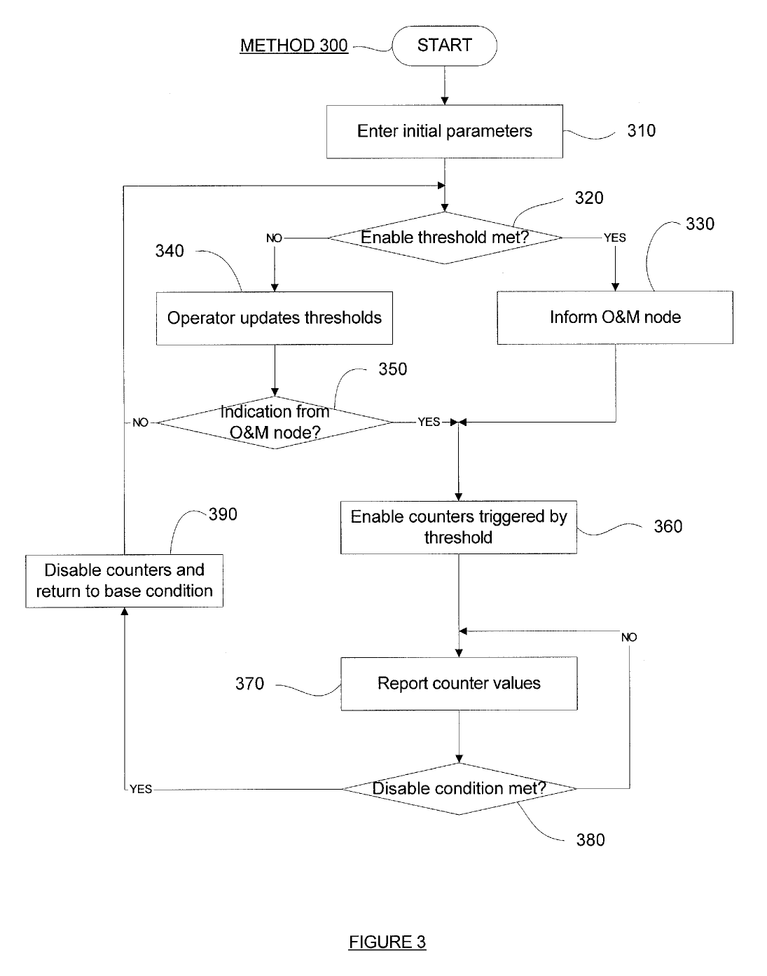

Implementation of these functions may be centralized or distributed within a communication network. In some exemplary embodiments, each of the functions may be a dedicated system; in others, they may be individual software applications. Interaction between the functions may be automatic or may be reliant upon user commands or interaction. In some exemplary embodiments, such as the exemplary method of FIG. 2, PMs may be enabled automatically if threshold values are met; in others, such as the exemplary method of FIG. 3, more user interaction may be required. Each of the exemplary methods 200 and 300 may govern the management of PMs for a single node of a network; such a method may then be applied independently to each of the nodes of a network containing many such nodes.

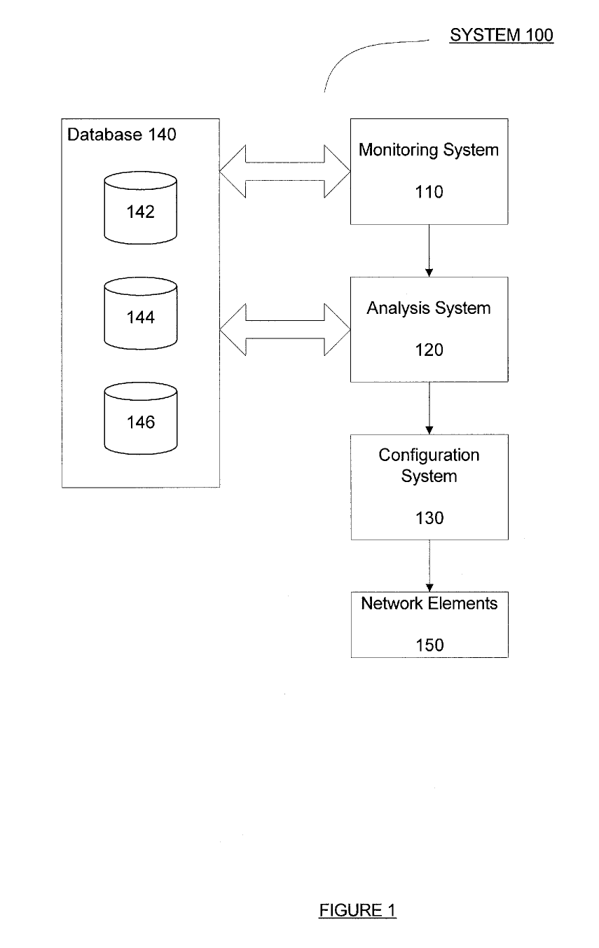

FIG. 1 shows an exemplary system 100 according to the present invention. Those of skill in the art will understand that this is merely a schematic representation. The components shown may be hardware, software, or a combination of the two. The system 100 includes a monitoring system 110, an analysis system 120, and a configuration system 130, each of which perform the respective functions described above. The monitoring system 110 and the analysis system 120 may communicate with a database 140. The database 140 may store PM data 142, CM data 144 and FM data 146. Additionally, the configuration system 130 may communicate with various network elements 150 in order to activate and deactivate PMs as required.

FIG. 2 illustrates an exemplary method 200 according to the present invention. In step 210, an initial set of parameters is defined for a node (e.g, one of the network elements 150 of the system 100). These parameters may govern the operation of the monitoring system 110, the analysis system 120 and the configuration system 130, and may help to determine how frequently PMs may be activated, what PMs may be active for various scenarios, etc. For example, for each of the monitored PMs, the operator may define a threshold for enabling the PM and a threshold for disabling the PM. In some examples, the system administrator or other user may determine that certain PMs should always be enabled (e.g., baseline PMs) and therefore no disable threshold may be set. In another example, the system administrator may determine that certain PMs are irrelevant and should not be enabled. Thus, the system administrator may initially configure the system 100 according to a desired operation. It should be noted that the initial setup may also be determined automatically based on historical data or other types of data. For example, when a new node is added, the node may be automatically initialized with parameters that mirror similar nodes on the network or the system 100 may view historical data associated with similar types of nodes and initialize the parameters based on this stored historical data. These parameters may be stored in the database 140.

In step 220, these parameters may be updated, such as by user interaction or automatically in view of prior results. For example, after receiving various results from collected PMs (as will be described in the following steps of method 200), the system administrator may manually revise the thresholds for some or all of the PMs based on the actual collected data. In another example, the collected data may trigger various rules concerning the automatic resetting of thresholds. For example, if the collected data indicates that a certain PM has never been enabled during system 100 operation, there may be a rule that automatically lowers the enable threshold so that the PM is enabled. In another example, if the collected data indicates that a certain PM has never been disabled and the collected data for the PM remains within defined boundaries, there may be a rule that automatically lowers the disable threshold for the PM. Those skilled in the art will understand that any number of rules for automatically resetting parameters may be included within the system 100. Thus, in step 220, the parameters may be reset manually or automatically.

In step 230, it is determined whether an enable threshold is met for a specific node (e.g., a data router, a radio base station, a radio network controller, a packet data network gateway, etc.) that is being monitored. An enable threshold may be, for example, a count of calls initiated at the specific node that cannot be completed over a predetermined time interval, a number of calls handled by a node, a number of data packets handled by the node, access failures, abnormally terminated calls or sessions, mobility failures, etc. In general, the enable threshold may be related to any operation of the network, but may tend to focus on those thresholds that indicate there is a problem with the network. When the network is operating properly, it is more likely that less PM data needs to be collected because there should be little or no problems to diagnose or correct. However, when there is a problem, the system administrator will desire the most amount of data to be able to diagnose and remedy the problem. However, this data should be relevant data that focuses on the particular problem to allow the system administrator to be efficient in diagnosing and remedying problems. The enable threshold may limit the count to specific types of calls, such as high probability completion calls, calls deemed to be at a certain level of significance, etc.

The determination may be made, for example, by the monitoring system 110 and the analysis system 120 of the system 100, together with information from the database 140. For example, the monitoring system 110 may monitor the number of uncompleted calls initiated by a particular node and store this information in the database 140. The analysis system 120 may compare the number of uncompleted calls against the enable threshold for various parameters stored in the database 140. It should also be noted that the analysis system may also perform additional analyses, such as determining if a problem is a major problem, etc. For example, the analysis system 120 may compare enable thresholds from multiple nodes to determine other characteristics of the particular problem, such as whether it is an isolated problem or a widespread problem.

If in step 230, it is determined that there are no current enable thresholds that have been met, the method continues to step 240 where it is determined whether the monitored node has received an indication of performance issues from any adjoining nodes. If so, then in step 250, it is determined whether the performance issues have an impact on the monitored node. For example, the analysis system 120 may determine that an adjacent node is experiencing a certain type of problem and that this type of problem may impact or be relevant to adjacent nodes. Information relating to problems that may be relevant to adjacent nodes may be store dint eh database 140 or as rules in the analysis system 120. If this is the case, or if a threshold was met in step 230, then in step 260, all PMs triggered by the threshold are enabled. This may be accomplished, for example, by the analysis system 120 and the configuration system 130 of the system 100, together with information from the database 140.

Alternately, if no indications have been received from adjoining nodes, or if the indications do not have impact on the monitored node, the method returns to step 220. Returning to step 260, after PMs are enabled, in step 270 the monitored node informs all adjoining nodes of the triggering event (this is the indication from an adjoining node that would be received in step 240). In step 280, the monitored node informs a monitoring agent (e.g., a user or an automated monitoring system) of the values recorded by the active PM or PMs.

In step 290, it is determined whether a disable condition is met. Similar to the enable thresholds discussed above, an exemplary disable threshold may relate to counts of calls that cannot be completed, for various reasons, over a predetermined period of time. Those of skill in the art will understand that while an enable threshold will typically be triggered when the number of incomplete calls is greater than an enable threshold, a disable threshold will typically be triggered when the number of incomplete calls is less than a disable threshold. For example, the monitoring system 110 may make this determination based on the values reported in step 280. If no disable condition is met, the method returns to step 280, wherein monitoring and reporting continue. If, in step 290, a disable condition is met, then in step 295, the PMs enabled in step 260 are disabled and monitoring returns to its base condition. Subsequently, the method returns to step 220. It should be noted that the exemplary method 200 does not provide a specified termination point; those of skill in the art will understand that the monitoring process may be continuously active while the monitored network is active. However, the method 200 may be terminated at any point during the monitoring process through user action.

FIG. 3 illustrates a second exemplary method 300 for administering performance measurements according to the present invention. In step 310, as in step 210 of the method 200, initial parameters of the method are defined. In step 320, as in step 230 of the method 200, it is determined whether a threshold is met to enable a PM or PMs. If so, in step 330 the monitored node informs the operations and maintenance node (“O&M node”; e.g., a central control location, operated by a user or automatically) of the activated threshold. Alternately, if no threshold is met at the monitored node, then in step 340 an operator may update threshold values in the manner described above with reference to step 220, and in step 350 the monitored node determines whether an instruction has been received from the O&M node to enable any necessary PMs due to thresholds at other nodes.

If enablement of PMs was triggered in steps 320 or 350, then in step 360, any PMs triggered by the threshold values are enabled. Subsequently, in step 370, results of the active PMs are reported as described above. If a disable condition is not met by the reported results, then monitoring and reporting continue in step 370. However, if a disable condition is met, then PMs are disabled in step 390, and the method returns to step 320 and continues monitoring for enablement thresholds. The method also may return to step 320 if no thresholds are triggered in steps 320 or 350. As noted above, the exemplary method 300 does not provide a specified termination point; those of skill in the art will understand that the monitoring process may be continuously active while the monitored network is active. However, the method 200 may be terminated at any point during the monitoring process through user action.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A computer readable storage medium including a set of instructions executable by a processor, the set of instructions being operable to:
monitor a parameter of a node of a communications network;
enable one of a plurality of performance measurements for the node based on an enable threshold of the parameter; and
disable the one of the performance measurements based on a disable threshold of the parameter.

2. The computer readable storage medium of claim 1, wherein the instructions are further operable to:
enable the one of the performance measurements based on a further parameter monitored for a further node of the communications network.

3. The computer readable storage medium of claim 2, wherein the further node adjoins the node.

4. The computer readable storage medium of claim 1, wherein enable threshold is set based on one of user interaction and a stored rule.

5. The computer readable storage medium of claim 2, wherein the instructions are further operable to:
determine whether a problem associated with the further parameter impacts the node.

6. The computer readable storage medium of claim 1, wherein the enable threshold is a count of incomplete calls over a time interval.

7. The computer readable storage medium of claim 6, wherein the incomplete calls are one of high priority calls and high percentage completion calls.

8. The computer readable storage medium of claim 1, wherein the one of the performance measurements measures one of packet loss, jitter, delay, access failures, mobility failures, radio resource management failures, transport network failures, abnormally terminated calls, abnormally terminated sessions and application layer failures

9. The computer readable storage medium of claim 1, wherein the disable threshold is a count of incomplete calls over a time interval.

10. A system, comprising:
a monitoring element configured to monitor a performance of nodes of a communication network;
an analysis element configured to analyze the performance; and
a configuration element configured to determine whether to enable a performance measurement for one of the nodes.

11. The system of claim 10, wherein the configuration element further enables the performance measurement when the need is determined.

12. The system of claim 11, wherein the monitoring element further monitors the performance measurement to determine a disable threshold.

13. The method of claim 12, wherein the disable threshold is a count of incomplete calls over a time interval.

14. The system of claim 13, wherein the configuration element further disables the performance measurement when the monitoring element determines the disable threshold.

15. The system of claim 10, wherein the configuration element determines whether to enable the performance measurement based on one of a current network performance and a predicted future network performance.

16. The system of claim 10, wherein the monitoring element compares the performance measurement to an enable threshold.

17. The system of claim 16, wherein the enable threshold is a count of incomplete calls over a time interval.

18. The system of claim 17, wherein the incomplete calls are one of high priority calls and high percentage completion calls.

19. The system of claim 17, wherein the time interval is one of predetermined and set by a user.

20. The system of claim 10, wherein the performance measurement measures one of packet loss, jitter, delay, access failures, mobility failures, radio resource management failures, transport network failures, abnormally terminated calls, abnormally terminated sessions and application layer failures.
